(19) United States
(12) Patent Application Publication
(10) Pub. No.: US 2026/0114662 A1
(43) Pub. Date: Apr. 30, 2026

(54) Cooking Dish Device

(71) Applicant: Damond Guyton, Tulsa, OK (US)

(72) Inventor: Damond Guyton, Tulsa, OK (US)

(21) Appl. No.: 19/372,989

(22) Filed: Oct. 29, 2025

Related U.S. Application Data
(60) Provisional application No. 63/713,226, filed on Oct. 29, 2024.

(51) Int. Cl. A47J 36/06; A47J 36/02

(52) U.S. Cl. CPC A47J 36/06; A47J 36/025

(57) ABSTRACT

A cooking dish device is disclosed which comprises a pot component that is a copper, non-stick pan or pot with a corresponding lid. The lid comprises a grip that also functions as a utensil holder for several different types of cooking utensils. Further, the dishware is useful for people who are in a rush, or the elderly to prevent creating a mess to clean up afterwards. Thus, users can safely and quickly slide off the lid while cooking to access the food while storing their utensils directly on the top of the lid. The handle comprises an easy gripping material to allow for fast and easy transport. Further, an optional drip tray could also be included to prevent messes.

### CROSS-REFERENCE TO RELATED APPLICATION

The present application claims priority to, and the benefit of, U.S. Provisional Application No. 63/713,226, which was filed on Oct. 29, 2024, and is incorporated herein by reference in its entirety.

### FIELD OF THE INVENTION

The present invention relates generally to the field of cooking dish devices. More specifically, the present invention relates to a cooking dish with a lid grip that can hold or retain utensils. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in cooking dish devices.

Generally, standard pot and pan lids feature a single knob or handle that can be difficult to grab, especially for those with limited physical dexterity. There is typically no place to store a utensil while cooking other than on the counter. Accordingly, people can risk making a mess by placing their cooking utensils down on the counter. Further, sliding off the pot or pan lid can be dangerous if the food underneath is exceptionally hot.

Accordingly, a pot constructed in accordance with the invention can easily hold and retain utensils when desired. Further, it is often necessary for people to place their cooking utensils somewhere besides down on their counters while cooking. This can cause safety and health risks as well as risk making a mess of the cooking area. Accordingly, cooking and cleaning up from cooking costs a lot of time, expending energy and developing discomfort at times.

Accordingly, there is a demand for an improved cooking dish device that allows users to place their cooking utensils on the dish itself rather than on the cooking area. More particularly, there is a demand for a cooking dish device that allows users to easily move the cooking dish and any utensils without risk of safety concerns or mess.

Therefore, there exists a long felt need in the art for a cooking dish device that provides users with a cooking pot or pan featuring a modified lid that can hold or retain utensils. There is also a long felt need in the art for a cooking dish device that features an easy grip handle to simultaneously move the pot and the spoon. Further, there is a long felt need in the art for a cooking dish device that includes an optional drip tray to further help prevent messes while cooking. Moreover, there is a long felt need in the art for a device that allows users to quickly remove the lid without worry of splashes and messes dripping onto the countertop or stove. Further, there is a long felt need in the art for a cooking dish device that saves considerable time and effort when cooking and cleaning up. Finally, there is a long felt need in the art for a cooking dish device that comprises a copper, non-stick pan or pot with a lid.

The subject matter disclosed and claimed herein, in one embodiment thereof, comprises a cooking dish device. The device is a modified cooking dish with a lid grip. The cooking dish device comprises a pot component that is a copper, non-stick pan or pot with a corresponding lid. The lid comprises a grip that also functions as a utensil holder for several different types of cooking utensils. Further, the dishware is useful for people who are in a rush, or the elderly to prevent creating a mess to clean up afterwards. Thus, users can safely and quickly slide off the lid while cooking to access the food, while storing their utensils directly on the top of the lid. The handle comprises an easy gripping material to allow for fast and easy transport. Further, an optional drip tray could also be included to prevent messes.

In this manner, the cooking dish device of the present invention accomplishes all of the forgoing objectives and provides users with a device that provides a cooking dish with a lid grip that can hold or retain utensils. The device is a cooking dish with a modified lid. The device can comprise easy gripping material over the handle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cooking dish device. The device is a modified cooking dish with a lid grip that can hold and retain utensils. The cooking dish device comprises a pot component that is a copper, non-stick pan or pot with a corresponding lid. The lid comprises a grip that also functions as a utensil holder for several different types of cooking utensils. Thus, users can safely and quickly slide off the lid while cooking to access the food while storing their utensils directly on the top of the lid. The handle comprises an easy gripping material to allow for fast and easy transport. Further, an optional drip tray could also be included to prevent messes.

In one embodiment, the cooking dish device can easily hold and retain utensils when desired. Further, it is often necessary for people to place their cooking utensils somewhere besides down on their counters while cooking. This can cause safety and health risks as well as risk making a mess of the cooking area. Accordingly, cooking and cleaning up from cooking costs a lot of time, expending energy and developing discomfort at times.

In one embodiment, the cooking dish device comprises a pot component that is a traditional pot or pan. The pot component comprises an exterior surface, an interior surface, and a side edge along the circumference of the circular pot component. However, the pot component can be any suitable shape and size as is known in the art, as long as the pot component is sized and shaped to sufficiently hold food and be placed on a stovetop or burner.

In one embodiment, the pot component is copper and non-stick with a corresponding lid.

The pot component also contains a handle which is integrated into the exterior surface of the pot component. The handle can be any length and width as is suitable to the device.

In one embodiment, the lid comprises a grip integrated into the top surface. This grip is a concave grip which is specifically manufactured to hold cooking utensils of various types and shapes. The grip allows a utensil to be placed head first on the lid of the pot component and to contain the utensil securely to the lid. Specifically, the grip includes a small ovular hole in the base of the concavity. This hole leads directly to the lid of the pot component and allows for the grip to not get messy with excess food that is on the cooking utensil.

In one embodiment, the pot component comprises a handle which is integrated into the side of the exterior surface. The handle is shaped like a traditional pot handle and comprises a gripping material which covers the entire handle. The gripping material is neoprene or any other suitable material. This allows the handle to be easily gripped by the user and transferred quickly without fear of mess. Neoprene would allow the grip to be durable in both dry and wet environments while also resisting cuts or other abrasions which could occur while cooking.

In one embodiment, the cooking dish device comprises an optional drip tray. The optional drip tray is a small rectangular tray which can be inserted in a space which is between the grip and the lid. The drip tray is placed directly under the small hole within the grip so as to catch any messes that come through that hole from the cooking utensil. The drip tray is comprised of a plastic or metal material or any other suitable material as is known in the art. The drip tray can be dishwasher safe and available to be slipped in and out of the grip.

In one embodiment, the material that the grip is comprised of can be a plastic, metal, or any other suitable material as is known in the art as well. The grip is integrated into the lid of the pot component so that it cannot be separated. The lid and grip can be utilized for a variety of shapes and sizes of pot components.

In another embodiment, the grip is suctioned to the top of the lid so that it can be extracted from the lid if necessary.

In another embodiment, there can be tracks for the grip which are integrated into the top of the lid. Thus, the grip can be taken off the lid and secured onto the lid by sliding the grip out and into the tracks. This allows the grip to be washed separately from the rest of the pot component.

In yet another embodiment, the cooking dish device comprises a plurality of indicia.

In yet another embodiment, a method of securing cooking utensils when not in use is disclosed. The method includes the steps of providing a cooking dish device comprising a pot component with a grip on the lid. The method also comprises using the cooking utensil to stir or beat the food within the pot component. Further, the method comprises taking the cooking utensil out of the pot component. The method also comprises pushing the cooking utensil into the grip on the top of the lid to secure it. Finally, the method comprises inserting the optional drip tray to catch any food remnants that come off the cooking utensil.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cooking dish device of the present invention showing the pot component, lid, and grip along with the optional drip tray in accordance with the disclosed architecture;

FIG. 2 illustrates a perspective view of one embodiment of the cooking dish device of the present invention showing the pot component and optional drip tray in accordance with the disclosed architecture;

FIG. 3 illustrates a perspective view of one embodiment of the cooking dish device of the present invention in use in accordance with the disclosed architecture; and

FIG. 4 illustrates a flowchart showing the method of securing cooking utensils when not in use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cooking dish device that provides users with a cooking pot or pan featuring a modified lid that can hold or retain utensils. There is also a long felt need in the art for a cooking dish device that features an easy grip handle to simultaneously move the pot and the spoon. Further, there is a long felt need in the art for a cooking dish device that includes an optional drip tray to further help prevent messes while cooking. Moreover, there is a long felt need in the art for a device that allows users to quickly remove the lid without worry of splashes and messes dripping onto the countertop or stove. Further, there is a long felt need in the art for a cooking dish device that saves considerable time and effort when cooking and cleaning up. Finally, there is a long felt need in the art for a cooking dish device that comprises a copper, non-stick pan or pot with a lid.

The present invention, in one exemplary embodiment, is a novel cooking dish device. The cooking dish device comprises a pot component that is a copper, non-stick pan or pot with a corresponding lid. The lid comprises a grip that also functions as a utensil holder for several different types of cooking utensils. Further, the dishware is useful for people who are in a rush, or the elderly to prevent creating a mess to clean up afterwards. Thus, users can safely and quickly slide off the lid while cooking to access the food while storing their utensils directly on the top of the lid. The handle comprises an easy gripping material to allow for fast and easy transport. Further, an optional drip tray could also be included to prevent messes. The present invention also includes a novel method of securing cooking utensils when not in use is disclosed. The method includes the steps of providing a cooking dish device comprising a pot component with a grip on the lid. The method also comprises using the cooking utensil to stir or beat the food within the pot component. Further, the method comprises taking the cooking utensil out of the pot component. The method also comprises pushing the cooking utensil into the grip on the top of the lid to secure it. Finally, the method comprises inserting the optional drip tray to catch any food remnants that come off the cooking utensil.

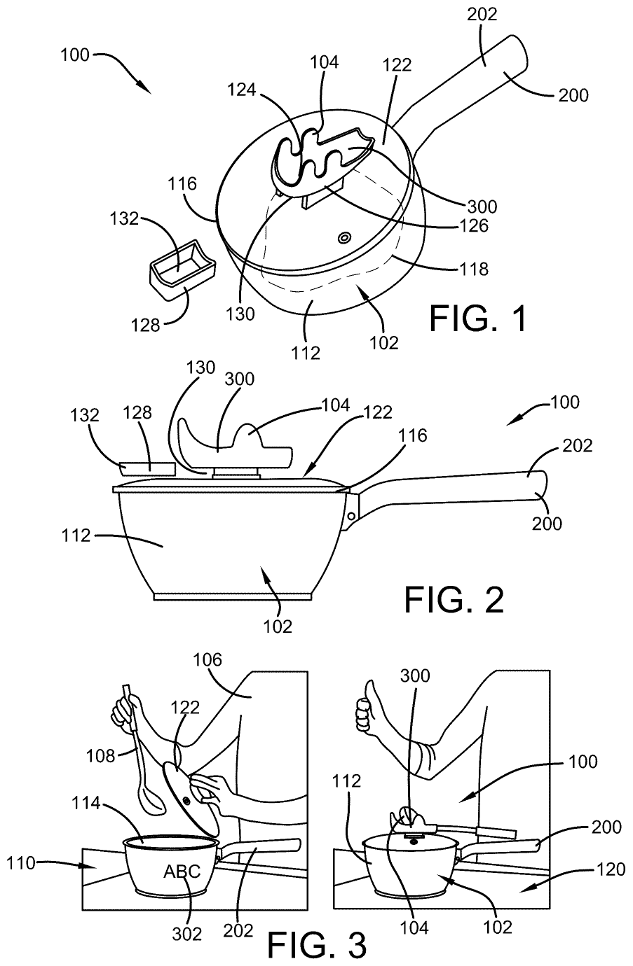

Referring initially to the drawings, FIG. 1 illustrates a perspective view of one embodiment of the cooking dish device 100 of the present invention. In the present embodiment, the cooking dish device 100 is an improved cooking dish device 100 that provides a user 106 with a cooking dish which comprises a grip on the lid. Specifically, the cooking dish device 100 comprises a pot component 102 and an attached grip 104. Thus, the pot component 102 can be a pot or a pan and provides extra storage with a grip 104 attached to it. Further, the grip 104 allows for less mess while cooking.

Generally, the cooking dish device 100 allows users 106 to store their cooking utensils 108 on the pot component 102 rather than on the kitchen counter 110. Further, the grip 104 allows for less mess and easy storage of the cooking utensil 108. Accordingly, users 106 can keep their cooking utensils 108 close to them, saving users 106 significant time and energy and preventing pain and discomfort.

Further, the pot component 102 comprises an exterior surface 112, an interior surface 114, and a side edge 116 along the circumference of the circular pot component 102. Additionally, the pot component 102 can be any suitable shape and size as is known in the art, as long as the pot component 102 is sized and shaped to sufficiently hold food 118 and be placed on a stovetop 120 or burner.

In one embodiment, the lid 122 of the pot component 102 comprises a grip 104 integrated into the top surface 124. The grip 104 is secured to the lid 122 via a securing means 134 such as screws, suction cups, or integrated tracks which could allow the grip 104 to be slid on and off the lid 122. This grip 104 is a concave grip 104 which is specifically manufactured to hold cooking utensils 108 of various types and shapes. The grip 104 allows a cooking utensil 108 to be placed head first on the lid 122 of the pot component 102 and to contain the cooking utensil 108 securely to the lid 122. The grip 104 includes a small ovular hole 124 in the base of the concavity 126. This small ovular hole 124 leads directly to the top surface 124 of the lid 122 and allows for the grip 104 to not get messy with excess food 118 that is on the cooking utensil 108.

Additionally, the cooking dish device 100 also comprises an optional drip tray 128. The optional drip tray 128 is a small rectangular tray which can be inserted in a space 130 which is between the grip 104 and the lid 122. The optional drip tray 128 is placed directly under the small ovular hole 124 within the grip 104 so as to catch any messes that come through that small ovular hole 124 from the cooking utensil 108. The optional drip tray 128 is comprised of a plastic or metal material 132 or any other suitable material 132 as is known in the art. The optional drip tray 128 is available to be slipped in and out of the grip 104.

As shown in FIG. 2, the pot component 102 is copper 204 and non-stick with a corresponding lid 122. The pot component 102 also contains a handle 200 which is integrated into the exterior surface 112 of the pot component 102. The handle 200 can be any length and width as is suitable to the cooking dish device 100. Further, as is stated supra, the pot component 102 may be any suitable size or shape as well to accommodate the different sizes of handles 200.

Generally, the handle 200 is shaped like a traditional pot handle, and comprises a gripping material 202 which covers the entire handle 200. The gripping material 202 is neoprene or any other suitable material. This allows the handle 200 to be easily gripped by the user 106 and allows the pot component 102 to be transferred quickly without fear of mess. Neoprene would allow the gripping material 202 to be durable in both dry and wet environments while also resisting cuts or other abrasions which could occur while cooking.

As shown in FIG. 3, the material 300 that the grip 104 is comprised of can be plastic, metal, or any other suitable material 300 as is known in the art as well. The grip 104 is integrated into the lid 122 of the pot component 102 so that it cannot be separated. The lid 122 and grip 104 can be utilized with a variety of shapes and sizes of pot components 102.

In yet another embodiment, the cooking dish device 100 comprises a plurality of indicia 302. The pot component 102 of the device 100 may include advertising, a trademark, or other letters, designs, or characters, printed, painted, stamped, or integrated into the pot component 102, or any other indicia 302 as is known in the art. Specifically, any suitable indicia 302 as is known in the art can be included, such as but not limited to, patterns, logos, emblems, images, symbols, designs, letters, words, characters, animals, advertisements, brands, etc., that may or may not be cooking, dishes, or brand related.

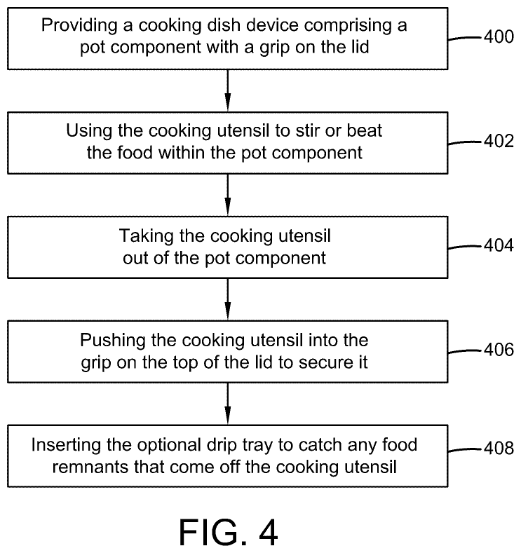

FIG. 4 illustrates a flowchart of the method securing cooking utensils when not in use. The method includes the steps of at 400 providing a cooking dish device comprising a pot component with a grip on the lid. The method also comprises at 402, using the cooking utensil to stir or beat the food within the pot component. Further, the method comprises at 404, taking the cooking utensil out of the pot component. The method also comprises at 406, pushing the cooking utensil into the grip on the top of the lid to secure it. Finally, the method comprises at 408, inserting the optional drip tray to catch any food remnants that come off the cooking utensil.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cooking dish device”, “cooking device”, “cooking utensil grip device”, and “device” are interchangeable and refer to the cooking dish device 100 of the present invention.

Notwithstanding the forgoing, the cooking dish device 100 of the present invention can be of any suitable size and configuration as is known in the art without affecting the overall concept of the invention, provided that it accomplishes the above stated objectives. One of ordinary skill in the art will appreciate that the cooking dish device 100 as shown in FIGS. 1-4 is for illustrative purposes only, and that many other sizes and shapes of the cooking dish device 100 are well within the scope of the present disclosure. Although the dimensions of the cooking dish device 100 are important design parameters for user convenience, the cooking dish device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features.

Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooking dish device that provides a user with a grip to store cooking utensils, the cooking dish device comprising:
a pot component; and
a grip;
wherein the grip is secured to a lid of the pot component and can act to store cooking utensils on the lid while not in use; and
further wherein the grip can be used for a plurality of cooking utensils.

2. The cooking dish device of claim 1, wherein the pot component is a traditional pot or pan which is comprised of copper and non-stick.

3. The cooking dish device of claim 2, wherein the pot component comprises an exterior surface, an interior surface, and a side edge along a circumference of the pot component.

4. The cooking dish device of claim 3, wherein the pot component may come in multiple shapes and sizes as long as the pot component may suitably hold food as well as fit on a stovetop or burner.

5. The cooking dish device of claim 4, wherein the grip is secured to a top surface of the lid via a securing means.

6. The cooking dish device of claim 5, wherein the grip is shaped in a concave shape with a small ovular hole at a base of concavity.

7. The cooking dish device of claim 6, wherein the grip comprises a space between the base of the concavity and the lid of the pot component.

8. The cooking dish device of claim 7, wherein an optional drip tray may slide within a space between the base of the concavity and the lid.

9. The cooking dish device of claim 8, wherein the handle of the pot component is integrated into a side of the exterior surface of the pot component.

10. The cooking dish device of claim 9, wherein the handle comprises a gripping material which encompasses the entire handle.

11. The cooking dish device of claim 10, wherein the grip is comprised of a plastic material, metal material.

12. The cooking dish device of claim 11 further comprising a plurality of indicia.

13. A cooking dish device that provides a user with a grip on their cooking dish to hold cooking utensils, the cooking dish device comprising:
a pot component configured in a shape of a traditional pot or pan with a lid; and
a grip;
wherein the pot component comprises an exterior surface, an interior surface, and a side edge along a circumference of the pot component;
wherein the pot component is available in different sizes and shapes;
wherein the grip is integrated into a top surface of the lid and secured onto the lid via a securing means;
wherein the grip is shaped to secure many different cooking utensils;
wherein the grip is concave with a small ovular hole at a bottom of concavity;
wherein the grip contains a space between the base of the concavity and the top surface of the lid; and
further wherein an optional drip tray is able to slide into the space between the base of the concavity and the top surface of the lid.

14. The cooking dish device of claim 13 further comprising a plurality of indicia.

15. The cooking dish device of claim 14, wherein the pot component also comprises a handle which is integrated into a side of the exterior surface.

16. The cooking dish device of claim 15, wherein the handle is completely encased in a gripping material.

17. The cooking dish device of claim 16, wherein the pot component is copper and non-stick.

18. The cooking dish device of claim 17 further wherein the grip is comprised of a plastic material or metal material.

19. The cooking dish device of claim 18, wherein cooking utensils are secured into the grip by pushing the cooking utensils until the grip curves up over the cooking utensils.

20. A method of securing cooking utensils when not in use, the method comprising the following steps:
providing a cooking dish device comprising a pot component with a grip on the lid;
using the cooking utensil to stir or beat the food within the pot component;
taking the cooking utensil out of the pot component;
pushing the cooking utensil into the grip on the top of the lid to secure it; and
inserting the optional drip tray to catch any food remnants that come off the cooking utensil.
